(19) United States
(12) Patent Application Publication
(10) Pub. No.: US 2005/0225798 A1
(43) Pub. Date: Oct. 13, 2005

(54) Distributed-printing control system, network printer, printer, distributed-printing control terminal, distributed-printing control program and storage medium, and distributed-printing control method

(76) Inventor: Taro Ishige, Beppu (JP)

Correspondence Address: HARNESS, DICKEY & PIERCE, P.L.C., P.O. BOX 828, BLOOMFIELD HILLS, MI, 48303, US

(21) Appl. No.: 11/102,924

(22) Filed: Apr. 8, 2005

(30) Foreign Application Priority Data
Apr. 12, 2004 (JP) 2004-116711
Jan. 18, 2005 (JP) 2005-010442

(51) Int. Cl. G06F 15/00

(52) U.S. Cl. 358/1.15

(57) ABSTRACT

A distributed-printing control system suited for preventing printed matters based on different print requests from being outputted jumbled together is provided. When a distributed-printing control server receives a distributed-printing request from a host terminal, the distributed-printing control server sends a distributed-print start notification to a subject-of-distributed-printing printer before a start of distributed printing, generates a distributed-unit-print request in accordance with the received distributed-print request, sends the generated distributed-unit-print request to the subject-of-distributed-printing printer, and sends a distributed-print end notification to the subject-of-distributed-printing printer after an end of distributed printing. When the network printer receives a distributed-unit-print request or an ordinary print request, the network printer takes control of printing depending upon the received distributed-unit-print request or ordinary print request, whereas the network printer is to prevent a printing as to an ordinary print request received in a time from a reception of the distributed-print start notification to a reception of the distributed-print end notification.

### RELATED APPLICATIONS

This application claims priority to Japanese Patent Application Nos. 2004-116711 filed Apr. 12, 2004 and 2005-010442 filed Jan. 18, 2005 which are hereby expressly incorporated by reference herein in their entirety.

### BACKGROUND

1. Technical Field

The present invention relates to a system, printer, terminal, program and storage medium, and method for effecting control of distributed printing, and more particularly to a distributed-printing control system, network printer, printer, distributed-printing control terminal, distributed-printing control program and storage medium, and distributed-printing control method suited for preventing printed matters from different print requests from being jumbled together when outputted.

2. Related Art

Recently, attention has been drawn to distributed-printing systems for printing of a great deal of printed matters at high speed by use of a plurality of network printers. In a distributed-printing system, generally, a distributed-printing control server is to receive a print request sent from a user and segment the received distributed-print request by the number of copies or by page. A variety of patterns are to be considered in the method of segmenting a distributed-print request. With a certain provision of the distributed-printing control server, there is a fear, as to one distributed-print request, that a plurality of distributed-unit-print requests (referring to print requests for a printing job handled by one network printer) will be sent to one subject-of-distributed-printing printer. Such distributed-printing systems include a known distributed-printing system disclosed in JP-A-2002-215369, for example.

In JP-A-2002-215369, the print amount assigned to the subject-of-distributed-printing printer is controlled based upon the status information about the subject-of-distributed-printing printer. In a print amount adjustment, particularly upon a printing amount increase, distributed-unit-print requests are additionally sent. For this reason, there is a high possibility that a plurality of distributed-unit print requests be sent to one subject-of-distributed-printing printer.

Meanwhile, an office-use distributed-printing system is often arranged to utilize a plurality of network printers in usual use, instead of preparing a network printer exclusively for distributed printing.

However, when applying a distributed-printing system such as that described in JP-A-2002-215369 to a distributed-printing system as described above, ordinary print requests may be sent to the network printer serving for distributed printing from those other than the distributed-printing control server. In such a case, if the ordinary print requests are inserted between the plurality of distributed-unit-print requests, the network printer might output a printed matter based on the distributed-print request and a printed matter based on the ordinary print request in a jumbled fashion. The undesirably jumbled printed matters forces the user to screen and organize the printed matters.

An advantage of the present invention is to provide a distributed-printing control system, network printer, printer, distributed-printing control terminal, distributed-printing control program and storage medium, and distributed-printing control method suited for preventing the printed matters from different print requests from being jumbled together when outputted.

### SUMMARY

In order to achieve the above object, a distributed-printing control system according to form 1 is a system communicably connected with a plurality of network printers and for effecting control of distributed printing, the system comprising:
a network printer occupying section that occupies, during distributed printing, the network printer to serve as a subject of distributed-printing among the plurality of network printers; and
a distributed-unit-print request transmitting section that transmits a distributed-unit-print request for a printing handled by one network printer out of a distributed printing, to the subject-of-distributed-printing printer depending upon a distributed-print request for distributed printing;
the network printer including a print request receiving section for receiving the distributed-unit-print request or other print request, and a print control section for effecting control of printing depending upon a distributed-unit-print request or other print request received at the print request receiving section;
the network printer occupying section selectively sending a distributed-print start notification representative of a start of distributed printing to the subject-of-distributed-printing printer before a start of distributed printing, and a distributed-print end notification representative of an end of distributed printing to the subject-of-distributed-printing printer after an end of distributed printing;
the print control section selectively preventing a printing as to the other print request received at the print request receiving section in a time from a reception of the distributed-print start notification to a reception of the distributed-print end notification.

With this configuration, the network printer occupying section sends a distributed-print start notification to the subject-of-distributed-printing printer before a start of distributed printing. The distributed-unit-print request transmitting section sends a distributed-unit-print request to the subject-of-distributed-printing printer depending upon the distributed-print request.

At the network printer, when the distributed-print start notification is received, a non-printing status is entered to prevent a printing as to the other print request until receiving a distributed-print end notification. Accordingly, in case the print request receiving section in that state receives another print request, the print control section prevents a printing as to the received other print request. Meanwhile, in case the print request receiving section receives the distributed-unit-print request, the print control section takes control of printing depending upon the received distributed-unit-print request.

Meanwhile, when distributed-printing is completed, the network printer occupying section sends a distributed-print end notification to the subject-of-distributed-printing printer.

At the network printer, when the distributed-print end notification is received, the non-printing status is cancelled. Accordingly, in case the print-request receiving section in that state receives another print request, the print control section effects control of printing depending upon the received other print request.

Due to this, even in case another print request is sent to the network printer under distributed-printing, no printing is performed as to the print request. Thus, the possibility of concurrently outputting the printed matter based on a distributed-print request and the printed matter based on the other print request can be reduced, as compared to conventional methods.

Here, the network printer occupying section and the distributed-unit-print request transmitting section may be provided anywhere, e.g. they can be provided at the network printer or another terminal. The “another terminal” includes a print-requesting terminal or a distributed-printing control terminal, for example.

Meanwhile, the network printer occupying section may be in any configuration provided to send a distributed-print end notification to the subject-of-distributed-printing printer after an end of distributed printing, e.g. configured to send a distributed-print end notification to all the subject-of-distributed-printing printers when printing is completed at all the subject-of-distributed-printing printers, or configured, for each of the subject-of-distributed-printing printers, to send a distributed-print end notification to the subject-of-distributed-printing printers when printing is completed at the relevant subject-of-distributed-printing printers. This is true for the distributed-printing control system of form 2 and the distributed-printing control terminal of form 14 (both described below).

Meanwhile, “distributed printing” refers to printing by distributing a print request, to be ordinarily processed on one network printer, onto a plurality of network printers based on the number of copies and by pages. This is true for the distributed-printing control system in form 2, the network printer in form 6, the printer in form 10, the distributed-printing control terminal in form 14, the distributed-printing control programs in forms 15 and 19, the storage mediums in forms 20 and 24, and the distributed-printing control methods in forms 25 and 26.

Meanwhile, “to effect control of distributed printing” refers to issuing an instruction for distributed printing to the network printer, wherein actual printing is not requisite. This includes, for example, distribution of a printing onto the network printers that are to serve as subjects-of-distributed-printing, securing (occupation) the network printers that are to serve as subjects-of-distributed-printing in order for distributed printing, releasing the network printers that are to serve as subjects-of-distributed-printing after distributed printing, regulation of distribution amount to the network printers that are to serve as subjects-of-distributed-printing in order to efficiently complete the printing by monitoring the printing status of the network printers that are to serve as subjects-of-distributed-printing, and acquisition of status information from the network printers that are to serve as subjects-of-distributed-printing. This is true for the distributed-printing control system in form 2, the network printer in form 6, the printer in form 10, the distributed-printing control terminal in form 14, the distributed-printing control programs in forms 15 and 19, the storage mediums in forms 20 and 24, and the distributed-printing control methods in forms 25 and 26.

“Occupation” refers only to printing based on a distributed-unit-print request without performing any printing based on other print requests. This is true for the distributed-printing control system in form 2, the network printer in form 6, the printer in form 10, the distributed-printing control terminal in form 14, the distributed-printing control programs in forms 15 and 19, the storage mediums in forms 20 and 24, and the distributed-printing control methods in forms 25 and 26.

“Before a start of distributed printing” refers to at least before transmitting a distributed-unit-print request. The transmission timing of a distributed-print start notification is a timing A in which the distributed-printing control terminal occupies the network printer according to a distributed-print request, a timing B in which the distributed-printing control terminal is started up (powered on), a timing C in which it become a designated time, a timing D in which a constant time elapsed from the last transmission of a distributed-print start notification, and a timing E when to occupy an alternative network printer, for example.

Timing A is a timing the distributed-printing control terminal receives a distributed-print request, a timing the distributed-printing control terminal starts the processing of a distributed-print request, a timing immediately before generation of a distributed-unit-print request to be issued by the distributed-printing control terminal to the network printer, and a timing immediately before issuance of a distributed-unit-print request by the distributed-printing control terminal to the network printer, for example.

Timing B is a case of all the time from a startup to shutdown of the network printer is used for distributed printing, for example.

Timing C is a case that the network printer is used from 6:00 to 12:00 everyday exclusively for distributed printing, for example.

Timing D is a case that the network printer under occupation is replaced every one hour after starting up the distributed-printing control terminal, and a timing of securing an alternative network printer because of a certain problem existing on the network printer under occupation, for example.

Timing E is a timing the amount of ink/remaining sheets becomes insufficient on the network printer currently under occupation, a timing error occurs on the network printer currently under occupation, a timing there are no response for a constant time period from the network printer a distributed-unit-print request has been issued, and a timing a constant time elapsed after occupation of a network printer occupied by the distributed-printing control terminal, for example.

The configuration using timing E is to be considered as a configuration that, in such a situation that the distributed-printing control terminal always occupies the network printer in a constant number, an alternative network printer is secured in order to equalize the occupation time over the network printer or upon a lapse of constant time from an occupation start of a certain network printer, followed by a release of the network printer, for example. This is true for the distributed-printing control system in form 2, the distributed-printing control terminal in form 14, the distributed-printing control program in form 19, the storage medium in form 24, and the distributed-printing control methods in forms 25 and 26.

“After an end of distributed printing” refers to at least after the time fixed is a start to print a final printing matter as to the distributed-unit-print request. The transmission timing of a distributed-print end notification is timing A in which the distributed-printing control terminal decides a network printer unnecessary in the course of processing the distributed-print request, timing B in which the distributed-printing control terminal is shut down (powered off), timing C in which it is a designated time, timing D in which a constant time elapsed from the last transmission of a distributed-print end notification, and timing E in which an alternative network printer could have been occupied, for example.

Timing A is a timing printing is completed as to the distributed-unit-print request made to the network printer, a timing printing is completed as to all the distributed-unit-print requests prepared in carrying out a distribution printing, a timing an error occurs on the network printer a distributed-unit-print request has been issued and the remaining requests are reassigned to other network printers, a timing there is no response for a constant time period from the network printer a distributed-unit-print request has been issued.

Timing B is for a case that all the time from a startup to shutdown of the network printer is used for distributed printing, for example.

Timing C is for a case that the network printer is used from 6:00 to 12:00 everyday exclusively for distributed printing, for example.

Timing D is for a case that the network printer under occupation is replaced every one hour after starting up the distributed-printing control terminal, for example.

Timing E is a timing an alternative network printer is secured for the network printer already under occupation and the network printer under occupation is unnecessary, for example. This is true for the distributed-printing control system in form 2, the distributed-printing control terminal in form 14, the distributed-printing control program in form 19, the storage medium in form 24, and the distributed-printing control methods in forms 25 and 26.

Furthermore, a distributed-printing control system according to form 2 is a system connected communicably with a print-requesting terminal for placing a request for printing, a plurality of network printers and a distributed-printing control terminal for control of the network printers, and for effecting control of distributed printing, the system comprising:
the print-requesting terminal having a distributed-print request transmitting section that sends a distributed-print request for distributed printing to the distributed-printing control terminal;
the distributed-printing control terminal having a distributed-print request receiving section that receives the distributed-print request, a network printer occupying section that occupies the network printer to serve as a subject of distributed printing among the plurality of network printers, and a distributed-unit-print request transmitting section that sends a distributed-unit-print request for a printing handled by one network printer out of a distributed printing, to the subject-of-distributed-printing printer depending upon a distributed-print request received at the distributed-print request receiving section;
the network printer having a print request receiving section that receives the distributed-unit-print request or other print request, and a print control section that effects control of printing depending upon the distributed-unit-print request or other print request received at the print request receiving section;
the network printer occupying section selectively sending a distributed-print start notification representative of a start of distributed printing to the subject-of-distributed-printing printer before a start of distributed printing, and a distributed-print end notification representative of an end of distributed printing to the subject-of-distributed-printing printer after an end of distributed printing;
the print control section selectively preventing a printing as to the other print request received at the print request receiving section in a time from a reception of the distributed-print start notification to a reception of the distributed-print end notification.

With this configuration, at the print-requesting terminal, the distributed-print request transmitting section sends a distributed-print request to the distributed-printing control terminal.

At the distributed-printing control terminal, when the distributed-print request is received at its distributed-print request receiving section, the network printer occupying section sends a distributed-print start notification to the subject-of-distributed-printing printer in advance of a start of distributed printing. Then, the distributed-print request transmitting section sends a distributed-unit-print request to the subject-of-distributed-printing printer depending upon the received distributed-print request.

The network printer, when the distributed-print start notification is received, becomes a non-printing status to prevent a printing as to the other print request until receiving a distributed-print end notification. Accordingly, upon receiving another print request by the print request receiving section in that state, no printing is performed based on the received other print request by the print control section. Meanwhile, when a distributed-unit-print request is received at the print request receiving section, the print control section takes control of printing depending upon the received distributed-unit-print request.

At the distributed-printing control terminal, when distributed printing is completed, the network printer occupying section sends a distributed-print end notification to the subject-of-distributed-printing printer.

At the network printer, when the distributed-print end notification is received, the non-printing status is cancelled.

Accordingly, in case the print request receiving section in that state receives another print request, the print control section takes control of printing depending upon the received other print request.

Due to this, even in case another print request is sent to the network printer under distributed printing, no printing is performed based on the print request. Thus, the possibility of concurrently outputting the printing matter based on a distributed-print request and the printing matter based on the other print request can be reduced, as compared to conventional methods.

Here, the distributed-printing control terminal may be in any configuration provided that it has a distributed-print request receiving section, a network printer occupying section and a distributed-unit-print request transmitting section. For example, it may further have a function of print-requesting terminal or a function of network printer. This is true for the distributed-printing control terminal in form 14, the distributed-printing control program in form 19, the storage medium in form 24, and the distributed-printing control methods in forms 25 and 26.

According to the distributed-printing control system of form 3, the network printer has a print request storing section that stores the other print request, the print control section being to reserve the received other print request in the print request storing section when receiving the other print request at the print request receiving section after receiving the distributed print start notification, and to effect control of printing depending upon the other print request reserved in the print request storing section when receiving the distributed print end notification.

With this configuration, at the network printer, when another print request is received at the print request receiving section after receiving a distributed-print start notification, the print control section reserves the received other print request in the print request storing section. Then, upon receiving a distributed-print end notification, the print control section takes control of printing depending upon the other print request reserved in the print request storing means.

This provides an effect that the network printer even currently under distributed printing is allowed to accept another print request.

Here, “to reserve” refers to a postponement as to another print request instead of immediately executing it. This is true for the network printer in form 7, the printer in form 11, the distributed-print control program in form 16, the storage medium in form 21, and the distributed-printing control method in form 27.

Meanwhile, the form that effects control of printing depending upon another print request reserved includes movement to a print standby state besides starting a printing due to receiving of a distributed-print end notification. This is true for the network printer in form 7, the printer in form 11, the distributed-print control program in form 16, the storage medium in form 21, and the distributed-printing control method in form 27.

According to the distributed-printing control system of form 4, the print control section selectively sending the received other print request as the distributed print request to the distributed printing control terminal when receiving the other print request at the print request receiving section in a time from a reception of the distributed print start notification to a reception of the distributed print end notification.

With this configuration, at the network printer, when the other print request is received at the print request receiving section in a time from a reception of the distributed print start notification to a reception of the distributed print end notification, the received other print request is sent as a distributed print request to the distributed printing control terminal.

At the distributed-printing control terminal, when the distributed-print request is received at the distributed-print request receiving section, the distributed-print request transmitting section sends a distributed-unit-print request to the subject-of-distributed-printing printer depending upon the received distributed-print request.

This provides an effect that the network printer even currently under distributed printing is allowed to accept another print request. Also, because another print request is processed as a distributed-print request, there is obtained an effect that a printing as to the other print request is efficiently done.

According to the distributed-printing control system of form 5, the print control section is to refuse the other print request in a time from a reception of the distributed print start notification to a reception of the distributed print end notification.

With this configuration, at the network printer, the other print request is refused by the print control section in a time from a reception of the distributed print start notification to a reception of the distributed print end notification.

Due to this, the network printer under distributed printing does not accept another print request. Thus, the possibility of effecting the distributed printing currently under processing can be reduced.

Here, refusal of other print requests includes not to receive other print requests at all besides receiving and then discarding a part or all of another print request, for example. In the latter case, it is satisfactory to make a reception port for the distributed-unit-print request and a reception port for the ordinary print request different from each other, and invalidate the reception port corresponding to the ordinary print request in the duration from receiving a distributed-print start notification to receiving a distributed-print end notification. This is true for the network printer in form 9, the printer in form 13, the distributed-print control program in form 18, the storage medium in form 23, and the distributed-printing control method in form 29.

Meanwhile, in order to achieve the object, a network printer in form 6 is a printer for effecting control of printing depending upon a distributed-unit-print request for a printing handled by one network printer out of a distributed printing, the printer comprising:
a print request receiving section that receives the distributed-unit-print request or other print request; and
a print control section that effects control of printing depending upon a distributed-unit-print request received at the print request receiving section or another print request;
the print control section selectively preventing a printing as to another print request received at the print request receiving section in a time from a reception of a distributed print start notification representative of a start of distributed printing to a reception of a distributed print end notification representative of an end of distributed printing.

This configuration provides an operation equivalent to that of the network printer in the distributed-print control system of form 1 or 2. Accordingly, the effect enjoyed is equivalent to that in the distributed-print control system of form 1 or 2.

The network printer of form 7 is a printer including a print request storing section that stores the other print request, the print control section being to reserve a received other print request in the print request storing section when receiving the other print request at the print request receiving section after receiving the distributed print start notification and, to effect control of printing depending upon the other print request reserved in the print request storing section when receiving the distributed print end notification.

This configuration provides an operation equivalent to that of the network printer in the distributed-print control system of form 3. Accordingly, the effect enjoyed is equivalent to that in the distributed-print control system of form 3.

The network printer of form 8 is a printer communicably connected with a distributed-printing control terminal for effecting control of the network printers depending upon a distributed print request for distributed printing, the print control section selectively sending a received other print request as the distributed print request to the distributed printing control terminal when receiving the other print request at the print request receiving section in a time from a reception of the distributed print start notification to a reception of the distributed print end notification.

This configuration provides an operation equivalent to that of the network printer in the distributed-print control system of form 4. Accordingly, the effect enjoyed is equivalent to that in the distributed-print control system of form 4.

The network printer of form 9 is a printer that the print control section is to refuse the other print request in a time from a reception of the distributed print start notification to a reception of the distributed print end notification.

This configuration provides an operation equivalent to that of the network printer in the distributed-print control system of form 5. Accordingly, the effect enjoyed is equivalent to that in the distributed-print control system of form 5.

A printer according to form 10 is a printer for effecting control of printing depending upon a distributed-unit-print request for a printing handled by one network printer out of a distributed printing, the printer comprising:
a print request receiving section that receives the distributed-unit-print request or other print request; and
a print control section that takes control of printing depending upon a distributed-unit-print request received at the print request receiving section or another print request;
the print control section selectively preventing a printing as to the other print request received at the print request receiving section in a time from a reception of a distributed print start notification representative of a start of distributed printing to a reception of a distributed print end notification representative of an end of distributed printing.

This configuration provides an operation equivalent to that of the network printer in the distributed-print control system of form 1 or 2. Accordingly, the effect enjoyed is equivalent to that in the distributed-print control system of form 1 or 2.

Here, the printer includes a printer not having an interface but having merely a slot to be fit with an interface besides a network printer having an interface for external communication.

The printer of form 11 is a printer including a print request storing section that stores the other print request, the print control section being to reserve a received other print request in the print request storing section when receiving the other print request at the print request receiving section after receiving the distributed print start notification and to effect control of printing depending upon the other print request reserved in the print request storing section when receiving the distributed print end notification.

This configuration provides an operation equivalent to that of the network printer in the distributed-print control system of form 3. Accordingly, the effect enjoyed is equivalent to that in the distributed-print control system of form 3.

The printer of form 12 is a printer communicably connected with a distributed-printing control terminal for effecting control of the network printers depending upon a distributed print request for distributed printing, the print control section selectively sending a received other print request as the distributed print request to the distributed printing control terminal when receiving the other print request at the print request receiving section in a time from a reception of the distributed print start notification to a reception of the distributed print end notification.

This configuration provides an operation equivalent to that of the network printer in the distributed-print control system of form 4. Accordingly, the effect enjoyed is equivalent to that in the distributed-print control system of form 4.

The printer of form 13 is a printer that the print control section is to refuse the other print request in a time from a reception of the distributed print start notification to a reception of the distributed print end notification.

This configuration provides an operation equivalent to that of the network printer in the distributed-print control system of form 5. Accordingly, the effect enjoyed is equivalent to that in the distributed-print control system of form 5.

Meanwhile, to achieve the above object, a distributed-printing control terminal according to form 14 is a terminal communicably connected with a plurality of network printers and for effecting control of the network printers, the terminal comprising:
a distributed-print request receiving section that receives a distributed-print request for distributed printing;
a network printer occupying section that occupies the network printer to serve as a subject of distributed printing among the plurality of printers during distributed printing;
a distributed-unit-print request transmitting section that sends a distributed-unit-print request for a printing handled by one of the network printers out of a distributed printing depending upon a distributed print request received at the distributed-print request receiving section;
the network printer occupying section selectively sending a distributed-print start notification representative of a start of distributed printing to the subject-of-distributed-printing printer before a start of distributed printing, and a distributed-print end notification representative of an end of distributed printing to the subject-of-distributed-printing printer after an end of distributed-printing.

This configuration provides an operation equivalent to the distributed-printing control terminal in the distributed-print control system of form 2. Accordingly, the effect enjoyed is equivalent to that in the distributed-print control system of form 2.

Meanwhile, to achieve the above object, a distributed-printing control program according to form 15 is a program to be executed by a computer operating as a network printer and for effecting control of printing depending upon a distributed-unit-print request for a printing handled by one network printer out of a distributed printing, the program including a program for the computer to execute a process comprising:
receiving the distributed-unit-print request or other print request; and
effecting control of printing depending upon the distributed-unit-print request or other print request received at the print request receiving section;
the print control selectively preventing a printing as to another print request received in the print request reception in a time from a reception of a distributed print start notification representative of a start of distributed printing to a reception of a distributed print end notification representative of an end of distributed printing.

With this configuration, when the program is read by the computer and executed processing according to the read-out program by the computer, an operation and effect is obtained equivalent to that of the network printer of Form 6.

The distributed-printing control program of form 16 is a program that the computer is allowed to use a print request storing section that stores the other print request,
the print control being to reserve the received other print request in the print request storing when receiving the other print request at the print request receiving section after receiving the distributed print start notification, and to effect control of printing depending upon the other print request reserved in the print request storing when receiving the distributed print end notification.

With this configuration, when the program is read by the computer and executed processing according to the read-out program by the computer, an operation and effect is obtained equivalent to that of the network printer of Form 7.

The distributed-printing control program of form 17 is a program that the computer is connected communicably with a distribution-printing control terminal for control of the network printers in accordance with a distributed-print request for distributed printing,
the print control selectively sending the received other print request as the distributed print request to the distributed printing control terminal when receiving the other print request in the print request receiving in a time from a reception of the distributed print start notification to a reception of the distributed print end notification.

With this configuration, when the program is read by the computer and executed processing according to the read-out program by the computer, an operation and effect is obtained equivalent to that of the network printer of Form 8.

The distributed-printing control program of form 18 is a program that:
the print control is to refuse the other print request in a time from a reception of the distributed print start notification to a reception of the distributed print end notification.

With this configuration, when the program is read by the computer and executed processing according to the read-out program by the computer, an operation and effect is obtained equivalent to that of the network printer of Form 9.

A distributed-printing control program according to form 19 is a program to be executed by a computer operating as a distributed-printing control terminal communicably connected with a plurality of network printers and for effecting control of the network printer, the program including a program for the computer to execute a process comprising:
receiving a distributed-print request for distributed printing;
occupying the network printer to serve as a subject of distributed printing among the plurality of printers during distributed printing;
sending a distributed-unit-print request for a printing handled by one of the network printers out of a distributed printing depending upon a distributed print request received at the distributed-print request receiving section;
the network printer occupation selectively sending a distributed-print start notification representative of a start of distributed printing to the subject-of-distributed-printing printer before a start of distributed printing, and a distributed-print end notification representative of an end of distributed printing to the subject-of-distributed-printing printer after an end of distributed-printing.

With this configuration, when the program is read by the computer and executed processing according to the read-out program by the computer, an operation and effect is obtained equivalent to that of the network printer of Form 14.

Here, network printer occupation may be in any form provided that to send a distributed-print end notification to the subject-of-distributed-printing printer after completing a distributed printing. For example, when printing is completed on all the subject-of-distributed-printing printers, distributed-print end notification may be sent to all the subject-of-distributed-printing printers. Otherwise, for each of the subject-of-distributed-printing printers, when printing is completed on the subject-of-distributed-printing printer, distributed-print end notification may be sent to the subject-of-distributed-printing printer. This is true of the storage medium of form 24, and the distributed printing control methods of forms 25 and 26.

Meanwhile, to achieve the above object, a storage medium according to form 20 is a medium storing a distributed-printing control program to be executed by a computer operating as a network printer and for effecting control of printing depending upon a distributed-unit-print request for a printing handled by one network printer out of a distributed printing, the medium recording a program for the computer to execute a process comprising:
receiving the distributed-unit-print request or other print request; and
effecting control of printing depending upon a distributed-unit-print request or other print request received at the print request receiving section;
the print control selectively preventing a printing as to another print request received in the print request reception in a time from a reception of a distributed print start notification representative of a start of distributed printing to a reception of a distributed print end notification representative of an end of distributed printing.

With this configuration, when the program is read by the computer and executed processing according to the read-out program by the computer, an operation and effect is obtained equivalent to that of the network printer of Form 6.

The storage medium of form 21 is a medium that the computer is allowed to use a print request storing section that stores the other print request,
the print control being to reserve the received other print request in the print request storing section when receiving the other print request in the print request receiving after receiving the distributed print start notification, and to effect control of printing depending upon the other print request reserved in the print request storing section when receiving the distributed print end notification.

With this configuration, when the program is read by the computer and executed processing according to the read-out program by the computer, an operation and effect is obtained equivalent to that of the network printer of Form 7.

The storage medium of form 22 is a medium that the computer is connected communicably with a distribution-printing control terminal for control of the network printers in accordance with a distributed-print request for distributed printing,
the print control selectively sending the received other print request as the distributed print request to the distributed printing control terminal when receiving the other print request in the print request reception in a time from a reception of the distributed print start notification to a reception of the distributed print end notification.

With this configuration, when the program is read by the computer and executed processing according to the read-out program by the computer, an operation and effect is obtained equivalent to that of the network printer of Form 8.

The storage medium of form 23 is a medium that:
the print control is to refuse the other print request in a time from a reception of the distributed print start notification to a reception of the distributed print end notification.

With this configuration, when the program is read by the computer and executed processing according to the read-out program by the computer, an operation and effect is obtained equivalent to that of the network printer of Form 9.

A storage medium according to form 24 is a medium storing a distributed-printing control program to be executed by a computer operating as a distributed-printing control terminal communicably connected with a plurality of network printers and for effecting control of distributed printing, the medium comprising:
receiving a distributed-print request for distributed printing;
occupying the network printer as a subject of distributed printing among the plurality of printers during distributed printing;
sending a distributed-unit-print request for a printing handled by one of the network printers out of a distributed printing depending upon a distributed print request received in the distributed-print request receiving section;
the network printer occupation selectively sending a distributed-print start notification representative of a start of distributed printing to the subject-of-distributed-printing printer before a start of distributed printing, and a distributed-print end notification representative of an end of distributed printing to the subject-of-distributed-printing printer after an end of distributed-printing.

With this configuration, when the program is read by the computer and executed processing according to the read-out program by the computer, an operation and effect is obtained equivalent to that of the printer of Form 14.

Meanwhile, to achieve the above object, a distributed-printing control method of form 25 is a method that communicably connected with a plurality of network printers and for effecting control of distributed printing, the method comprising:
occupying the network printer to serve as a subject of distributed printing among the plurality of network printers, during distributed printing; and
sending a distributed-unit-print request for a printing handled by one of the network printers out of a distributed printing depending upon a distributed-print request for distributed printing, to the subject-of-distributed-printing printer;
wherein, the following are included for the network printer:
receiving the distributed-unit-print request or other print request, and effecting control of printing depending upon the distributed-unit-print request or other print request received in the print request reception;
the network printer occupation selectively sending a distributed-print start notification representative of a start of distributed printing to the subject-of-distributed-printing printer before a start of distributed printing, and a distributed-print end notification representative of an end of distributed printing to the subject-of-distributed-printing printer after an end of distributed printing;
the print control selectively preventing a printing as to the other print request received in the print request reception in a time from a reception of the distributed-print start notification to a reception of the distributed-print end notification.

This provides an effect equivalent to that of the distributed-printing control system of form 1.

A distributed-printing control method of form 26 is a method that communicably connects with a print-requesting terminal for requesting for printing, a plurality of network printers and a distributed-printing control terminal for control of the network printers, and for effecting control of distributed printing, the method comprising:
for the print-requesting terminal:
sending a distributed-print request for distributed printing to the distributed-printing control terminal;
for the distributed-printing control terminal:
receiving the distributed-print request;
occupying the network printer to serve as a subject of distributed-printing among the plurality of network printers;
and sending a distributed-unit-print request for a printing handled by one of the network printers out of a distributed printing depending upon the distributed-print request received in the distributed-print request reception, to the subject-of- distributed-printing printer;
for the network printer:
receiving the distributed-unit-print request or other print request; and
effecting control of printing depending upon the distributed-unit-print request or other print request received in the print request reception;
the network printer occupation selectively sending a distributed-print start notification representative of a start of distributed printing to the subject-of-distributed-printing printer before a start of distributed printing, and a distributed-print end notification representative of an end of distributed printing to the subject-of-distributed-printing printer after an end of distributed printing;
the print control selectively preventing a printing as to the other print request received in the print request reception in a time from a reception of the distributed-print start notification to a reception of the distributed-print end notification.

This provides an effect equivalent to that of the distributed-printing control system of form 2.

The distributed-printing control method of form 27 is a method that the network printer has a print request storing section that stores the other print request, the print control being to reserve the received other print request in the print request storing section when receiving the other print request in the print request reception after receiving the distributed print start notification, and to effect control of printing depending upon the other print request reserved in the print request storing section when receiving the distributed print end notification.

This provides an effect equivalent to that of the distributed-printing control system of form 3.

The distributed-printing control method of form 28 is a method that the print control is to send the received other print request as the distributed print request to the distributed printing control terminal when receiving the other print request in the print request reception in a time from a reception of the distributed print start notification to a reception of the distributed print end notification.

This provides an effect equivalent to that of the distributed-printing control system of form 4.

The distributed-printing control method of form 29 is a method that
the print control is to refuse the other print request in a time from a reception of the distributed print start notification to a reception of the distributed print end notification.

This provides an effect equivalent to that of the distributed-printing control system of form 5.

### BRIEF DESCRIPTION OF THE DRAWINGS

FIG. 1 is a functional block diagram showing a functional outline of a network system to which the present invention is applied.

FIG. 2 is a block diagram showing a hardware arrangement of a distributed-printing control server 200.

FIG. 3 is a flowchart showing a distributed-print request process.

FIG. 4 is a block diagram showing a hardware arrangement of a network printer 300.

FIG. 5 is a flowchart showing a notification receiving process.

FIG. 6 is a flowchart showing a status-information providing process.

FIG. 7 is a flowchart showing a distributed-unit-print request process.

FIG. 8 is a flowchart showing an ordinary-print request process.

FIG. 9 is a flowchart showing an error notification process.

FIG. 10 is a flowchart showing an ordinary-print request process.

FIG. 11 is a flowchart showing an ordinary-print request process.

FIG. 12 is a figure showing a storage medium and its data structure.

### DETAILED DESCRIPTION

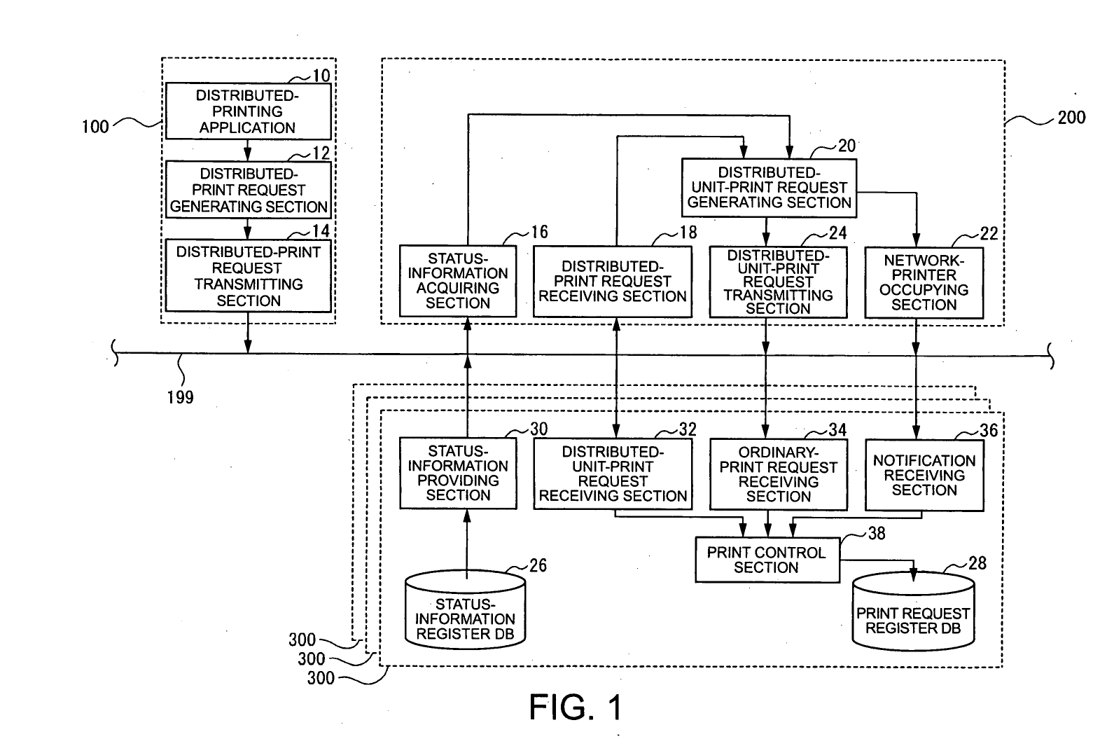

With reference to the drawings, explanation is now made regarding a first embodiment of the present invention. FIGS. 1 to 9 are figures showing a distributed-printing control system, network printer, printer, distributed-printing control terminal, distributed-printing control program and storage medium, and distributed-printing control method, in a first embodiment of the present invention.

This embodiment is the application of a distributed-printing control system, network printer, printer, distributed-printing control terminal, distributed-printing control program and storage medium, and distributed-printing control method of the invention to the case of carrying out a distributed printing by means of a plurality of network printers 300 under control of a distributed-printing control server 200 according to a distributed-print request from a host terminal 100, as shown in FIG. 1.

Referring to FIG. 1, explanation is made regarding the functional outline of a network system to which the invention is applied.

FIG. 1 is a functional block diagram showing the functional outline of the network system to which the invention is applied.

There are connected, with a network 199, a host terminal 100 provided for user to utilize, a plurality of network printers 300, and a distributed-printing control server 200 for control of the network printers 300, as shown in FIG. 1.

The host terminal 100 is configured, as shown in FIG. 1, with a distributed-printing application 10 that makes a distributed-printing of document data, a distributed-print request generating section 12 that generates a distributed-print request according to a print instruction from the distributed-printing application 10, and a distributed-print request transmitting section 14 that sends a distributed-print request generated at the distributed-print request generating section 12 to the distributed-printing control server 200.

The distributed-print request generating section 12 allows the user to select the subjects of distributed printing out of the plurality of network printers 300 and generates printing data in accordance with the document data provided from the distributed-printing application 10, thus generating a distributed-print request containing printer identification information for identifying the selected ones of the printer of subject-of-distributed-printing printers 300 and generated print data.

The distributed-printing control server 200 is configured, as shown in FIG. 1, with a status-information acquiring section 16 for acquiring status information indicative of a status of the network printer 300, a distributed-print request receiving section 18 for receiving a distributed-print request, a distributed-unit-print request generating section 20 for generating a distributed-unit-print request depending upon a distributed-print request received at the distributed-print request receiving section 18, a network-printer occupying section 22 for occupying the subject-of-distributed-printing printers 300 as subject-of-distributed-printing printers during distributed printing, a distributed-unit-print request transmitting section 24 for sending a distributed-unit-print request generated at the distributed-unit-print request generating section 20 to the subject-of-distributed-printing printer 300.

The distributed-unit-print request generating section 20 decides available ones for printing out of the subject-of-distributed-printing printers 300, depending upon the printer identification information contained in the distributed-print request received at the distributed-print request receiving section 18. It then makes a division of the distributed-print request received at the distributed-print request receiving section 18, depending upon the status information acquired at the status-information acquiring section 16, and generates a distributed-unit-print request respectively for the determined subject-of-distributed-printing printers 300.

The network-printer occupying section 22, before a start of distributed printing, sends a distributed-print start notification representative of a start of distributed printing to the subject-of-distributed-printing printers 300 determined by the distributed-unit-print request generating section 20. After completing the distributed-printing, it sends a distributed-print end notification representative of an end of distributed printing to the subject-of-distributed-printing printers 300 determined by the distributed-unit-print request generating section 20.

The network printer 300 is configured, as shown in FIG. 1, with a status-information register database (hereinafter, database abbreviated merely as DB) 26 for registering therein the status information of the network printer 300 concerned, a print-request register DB 28 for registering therein the ordinary print request (referring to a print request excepting distributed-print and distributed-unit-print requests), and a status-information providing section 30 for providing status information in the status-information register DB 26 to the distributed-printing control server 200.

The network printer 300 is further configured with a distributed-unit-print request receiving section 32 for receiving a distributed-unit-print request, an ordinary-print request receiving section 34 for receiving an ordinary-print request, a notification receiving section 36 for receiving a distributed-print start notification or a distributed-print end notification, and a print control section 38 for effecting control of printing depending upon a distributed-unit-print request received at the distributed-unit-print request receiving section 32 and an ordinary-print request received at the ordinary-print request receiving section 34.

The print control section 38, when the ordinary-print request receiving section 34 receives an ordinary print request after the notification receiving section 36 receives a distributed-print start notification, reserves the received ordinary print request in the print-request register DB 28. When receiving a distributed-print end notification at the notification receiving section 36, it takes control of printing depending upon the ordinary print request reserved in the print-request register DB 28.

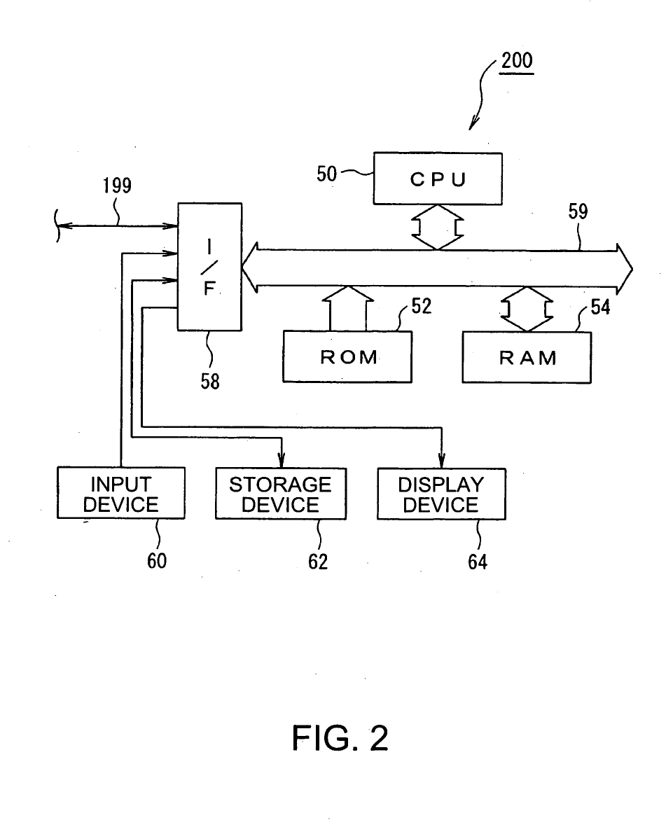

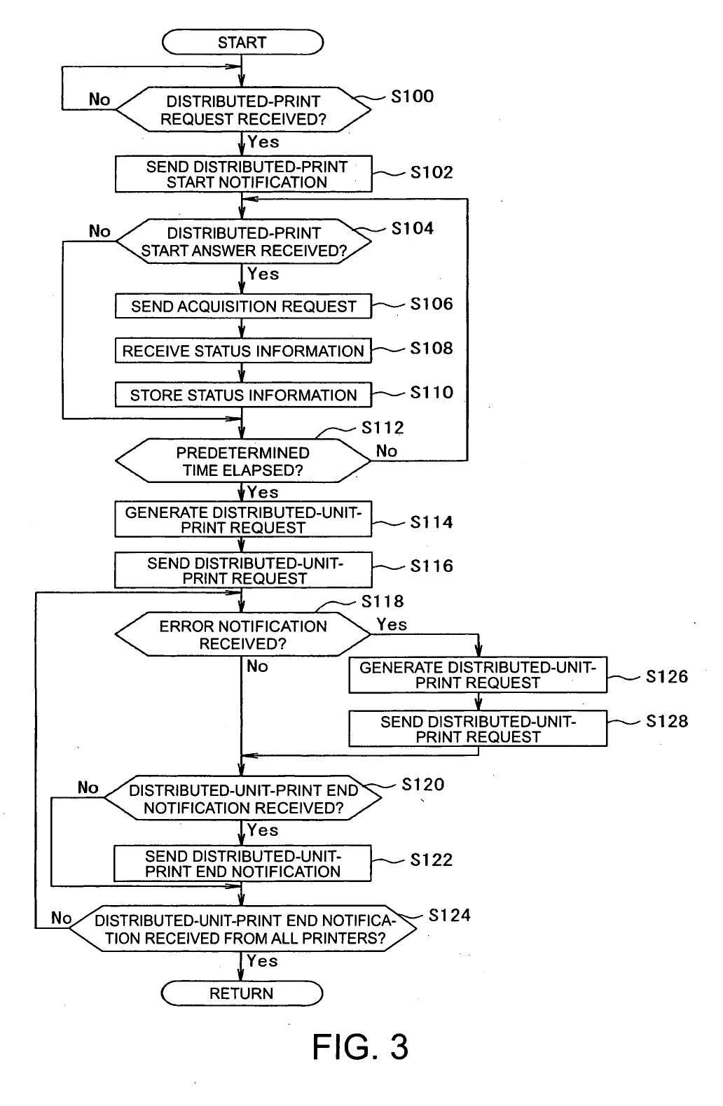

Referring to FIGS. 2 and 3, explanation is made in detail on the configuration of the distributed-printing control server 200.

FIG. 2 is a block diagram showing a hardware arrangement of the distributed-printing control server 200.

The distributed-printing control server 200 is arranged, as shown in FIG. 2, with a CPU 50 for controlling the operation and system overall depending upon a control program, a ROM 52 previously storing a control program, etc. for the CPU 50 in its predetermined domain, a RAM 54 for storing the data read out of the ROM 52, etc. and an operation result required in the operation process at the CPU 50, and an I/F 58 for mediating to input/output data to/from external devices. These are connected with one another by a bus 59, as a signal line for data transfer, in order to exchange data.

The I/F 58 is connected, as external units, with an input device 60, such as a keyboard and a mouse, as a human interface for inputting data, a storage device 62 for storing data, tables, etc. in the form of files, a display device 64 for displaying a screen depending upon an image signal, and a signal line for connection to a network 199.

The storage device 62 is stored with a printer-information register table registering therein printer identification information and network addresses with a correspondence, for each of the network printers 300.

The CPU 50, comprising a micro-processing unit (MPU), etc., is to start up a predetermined program stored in a predetermined domain of the ROM 52 and execute a distributed-print request process shown in a flowchart of FIG. 3 according to the program thereof.

FIG. 3 is a flowchart showing a distributed-print request process.

The distributed-print request process is a process to be realized as the status-information acquiring section 16, the distributed-print request receiving section 18, the distributed-unit-print request generating section 20, the network-printer occupying section 22 and the distributed-unit-print request transmitting section 24. When it is executed at the CPU 50, the process at first moves to step S100 as shown in FIG. 3.

At step S100, it is determined whether or not a distributed-print request is received. When it is determined that a distributed-print request (Yes) is not received, the process moves to step S102. When it is determined not to be so (No), the process waits at step S100 until receiving a distributed-print request.

At step S102, printer identification information is extracted out of the received distributed-print request, to read a network address corresponding to the extracted printer identification information from the printer-information register table. Depending upon the read-out network address, a distributed-print start notification is sent to the subject-of-distributed-printing printer 300, and the process moves to step S104.

At step S104, it is determined whether or not a distributed-print start answer as an answer to the distributed-print start notification is received. When it is determined that a distributed-print start answer is received (Yes), the process moves to step S106, to send an acquisition request for status information to the subject-of-distributed-printing printer 300 depending upon the network address read out. The process moves to step S108, to receive status information. The process then moves to step S110 where the received status information is stored in the storage device 62 and registered as a subject-of-distributed-printing printer 300 which can print. The process moves to step S112.

At step S112, it is determined whether or not a predetermined time elapsed from sending a distributed-print start request. When it is determined that a predetermined time has lapsed (Yes), the process moves to step S114.

At step S114, print data is extracted out of the received distributed-print request. Depending upon the extracted print data and the status information in the storage medium 62, a decision is made as to the number of copies, pages, etc. to be handled printing by the subject-of-distributed-printing printer 300. Depending upon the extracted print data, print data is generated for each subject-of-distributed-printing printer 300 in accordance with the number of copies, pages, etc. determined for the subject-of-distributed-printing printer 300, to thereby generate a distributed-unit-print request containing the generated print data. Then, the process moves to step S116.

At step S116, for each subject-of-distributed-printing printer 300, a distributed-unit-print request, generated for the subject-of-distributed-printing printer 300, is sent to the subject-of-distributed-printing printer 300 depending upon the read-out network address. The process moves to step S118.

At step S118, it is determined whether or not an error notification is received. When it is determined that an error notification is not received (No), the process moves to step S120 where it is determined whether or not a distributed-unit-print end notification representative of an end of distributed unit printing is received. When it is determined that a distributed-unit-print end notification is received (Yes), the process moves to step S122 where, depending upon the read-out network address, a distributed-print end notification is sent to the subject-of-distributed-printing printer 300 a distributed-unit-print end notification has been done. The process then moves to step S124.

At step S124, it is determined whether or not distributed-unit-print end notifications from all the subject-of-distributed-printing printers 300 are received. When it is determined that distributed-unit-print end notifications from all the subject-of-distributed-printing printers 300 (Yes) are received, the process in series is terminated for return to the former process.

Meanwhile, when it is determined at step S124 that there is no reception of the distributed-unit-print end notification from any of the subject-of-distributed-printing printers 300 (No), the process moves to step S118.

Meanwhile, when it is determined at step S120 that there is no reception of distributed-unit-print end notification (No), the process moves to step S124.

Meanwhile, when it is determined at step S118 that an error notification is received (Yes), the process moves to step S126 where distributed-unit-print requests are generated for the respective ones of the remaining subject-of-distributed-printing printers 300 in a procedure similar to step S114 so that the subject-of-distributed-printing printer 300 notified of an error can share the unprocessed portion of printing to the remaining subject-of-distributed-printing printers 300. Also, printing is cancelled as to the subject-of-distributed-printing printer 300 notified of an error.

Then, the process moves to step S128 where, for each of the remaining subject-of-distributed-printing printer 300, a distributed-unit-print request generated as to the subject-of-distributed-printing printer 300 is sent to the subject-of-distributed-printing printer 300 depending upon the read-out network address. The process moves to step S120.

Meanwhile, when it is determined at step S112 that there is no lapse of predetermined time from sending a distributed-print start notification (No), the process moves to step S104.

Meanwhile, when it is determined at step S104 that a distributed-print start answer is not received (No), the process moves to step S112.

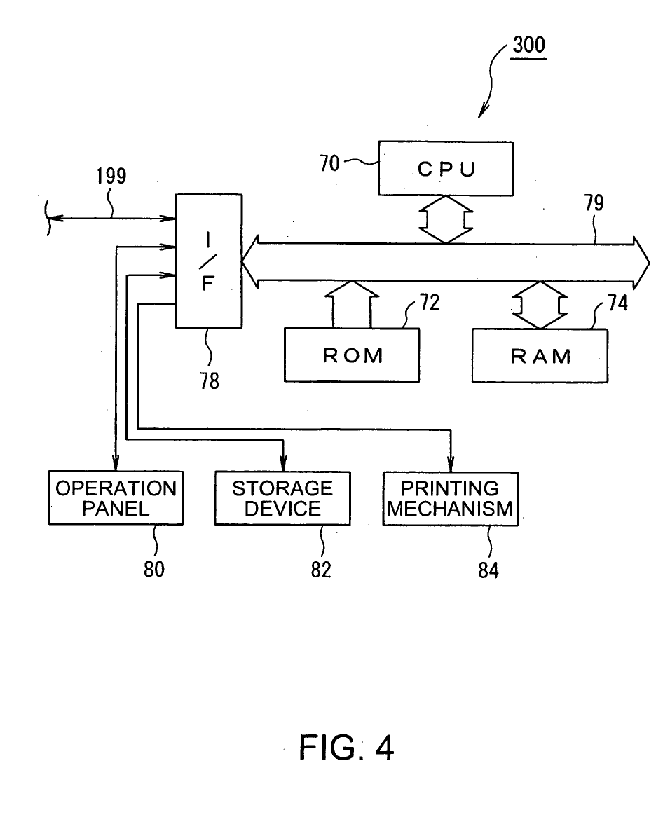

Referring to FIGS. 4 to 9, explanation is made in detail on the configuration of the network printer 300.

FIG. 4 is a block diagram showing a hardware arrangement of the network printer 300.

The network printer 300 is arranged, as shown in FIG. 4, with a CPU 70 for effecting control of the operation and system overall depending upon a control program, a ROM 72 previously storing a control program, etc. for the CPU 50 in its predetermined domain, a RAM 74 for storing the data read out of the ROM 72, etc. and an operation result required in the operation process at the CPU 70, and an I/F 78 for mediating inputs/outputs data to/from external devices. These are connected with one another by a bus 79, as a signal line for data transfer, in order to exchange data.

The I/F 78 is connected, as external devices, with an operation panel 80, such as a touch panel, as a human interface for inputting and displaying data, a storage device 82 for storing data, tables, etc. in the form of files, a printing mechanism 84 made by a mechanism required for printing in accordance with network printer 300 type, e.g. inkjet printer or laser printer, and a signal line for connection to a network 199.

The storage device 82 is structured with a status-information register DB 26 and a print-request register DB 28.

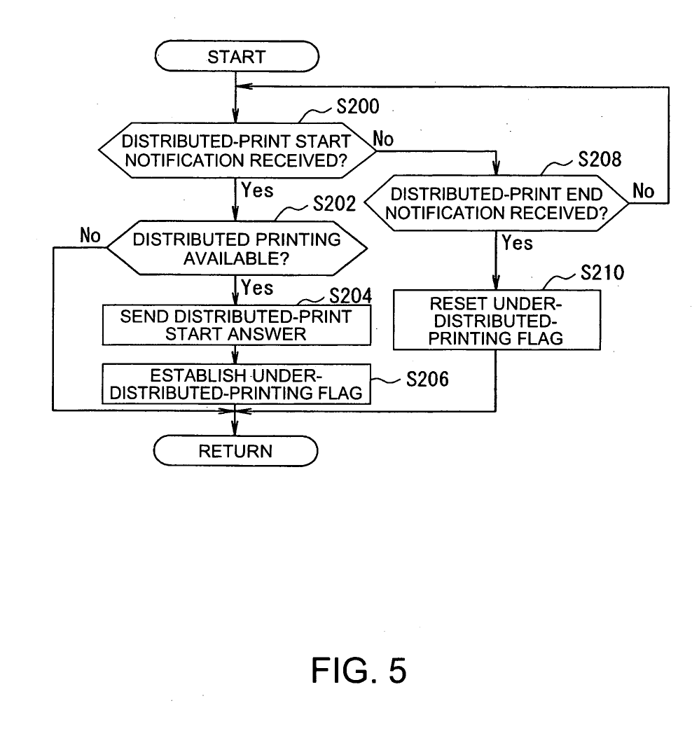

The CPU 70, comprising a micro-processing unit (MPU), etc., is to start up a predetermined program stored in a predetermined domain of the ROM 72 and execute, time-divisionally, a notification reception process, status-information providing process, distributed-unit-print request process, ordinary-print request process and error notification process shown in a flowchart of FIGS. 5 to 9 according to the program thereof.

Referring to FIG. 5, first explained is a notification reception process in detail.

FIG. 5 is a flowchart showing a notification receiving process.

The notification receiving process is a process to be realized as a notification receiving section 36. When it is executed in the CPU 70, the process first moves to step S200 as shown in FIG. 5.

At step S200, it is determined whether or not a distributed-print start notification is received. When it is determined that a distributed-print start notification is received (Yes), the process moves to step S202 where it is determined whether or not the network printer 300 concerned is allowed for printing (available and permitted to print), depending upon the status information in the storage device 82. When it is determined that the network printer 300 concerned is allowed for printing (Yes), the process moves to step S204.

At step S204, a distributed-print start answer is sent to the distributed-printing control server 200. The process moves to step S206, to establish an under-distributed-printing flag representative of whether or not the network printer 300 concerned is under distributed-printing. Thus, the process in series is terminated for return to the former process.

Meanwhile, when it is determined at step S202 that the network printer 300 concerned is not allowed for printing (No), the process in series is terminated for return to the former process.

Meanwhile, when it is determined at step S200 that a distributed-print start notification is not received (No), the process moves to step S208 where it is determined whether or not a distributed-print end notification is received. When it is determined that a distributed-print end notification is received (Yes), the process moves to step S210 where the under-distributed-printing flag is established. Thus, the process in series is terminated for return to the former process.

Meanwhile, when it is determined at step S208 that a distributed-print end notification is not received (No), the process moves to step S200.

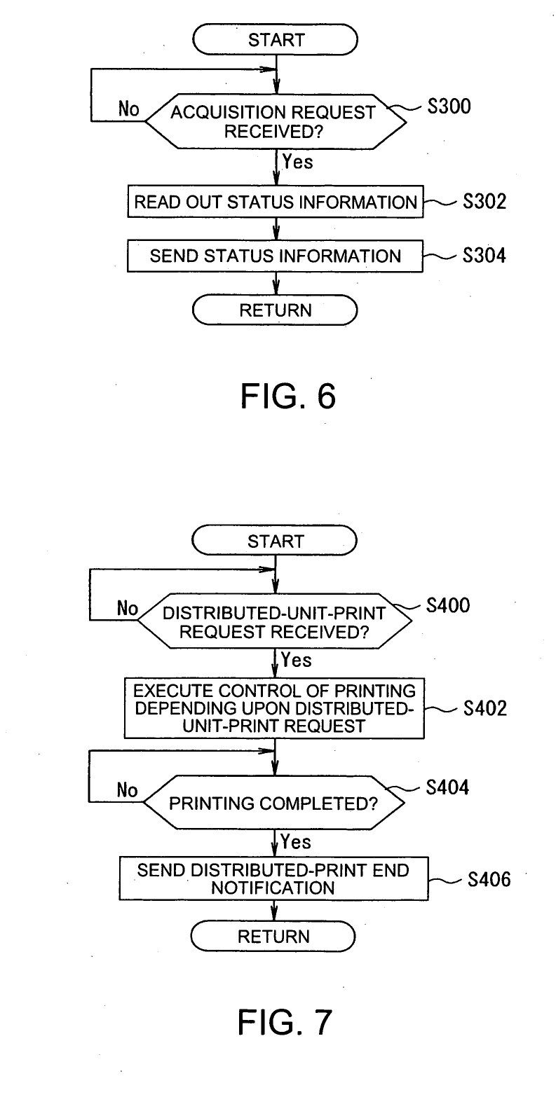

Referring to FIG. 6, explanation is made in detail on the status-information providing process.

FIG. 6 is a flowchart showing a status-information providing process.

The status-information providing process is a process to be executed as the status-information providing section 30. When it is executed in the CPU 70, the process first moves to step S300 as shown in FIG. 6.

At step S300, it is determined whether or not a status-information acquisition request is received. When it is determined that a status-information acquisition request is received (Yes), the process moves to step S302. When it is determined not to be so (No), the process waits at step S300 until a status-information acquisition request is received.

At step S302, status information is read out of the storage device 82. The process moves to step S304 where the read-out status information is sent to an acquisition-request transmission source. The process in series is terminated for return to the former process.

Referring to FIG. 7, explanation is now made in detail on the distributed-unit-print request process.

FIG. 7 is a flowchart showing a distributed-unit-print request process.

The distributed-unit-print request process is a process to be executed as a part of the distributed-unit-print request receiving section 32 and print control section 38. When it is executed in the CPU 70, the process moves to step S400 as shown in FIG. 7.

At step S400, it is determined whether or not a distributed-unit-print request is received. When it is determined that a distributed-unit-print request is received (Yes), the process moves to step S402. When it is determined not to be so (No), the process waits at step S400 until a distributed-unit-print request is received.

At step S402, print data is extracted out of the received distributed-unit-print request, to control the printing mechanism 84 depending upon the extracted print data. The process moves to step S404.

At step S404, it is determined whether or not printing by the printing mechanism 84 is completed. When it is determined that printing by the printing mechanism 84 is completed (Yes), the process moves to step S406 where a distributed-unit-print end notification is sent to the distributed-printing control server 200. Thus, the process in series is terminated for return to the former process.

Meanwhile, when it is determined at step S404 that printing by the printing mechanism 84 is not completed (No), the process waits at step S404 until the printing by the printing mechanism 84 completes.

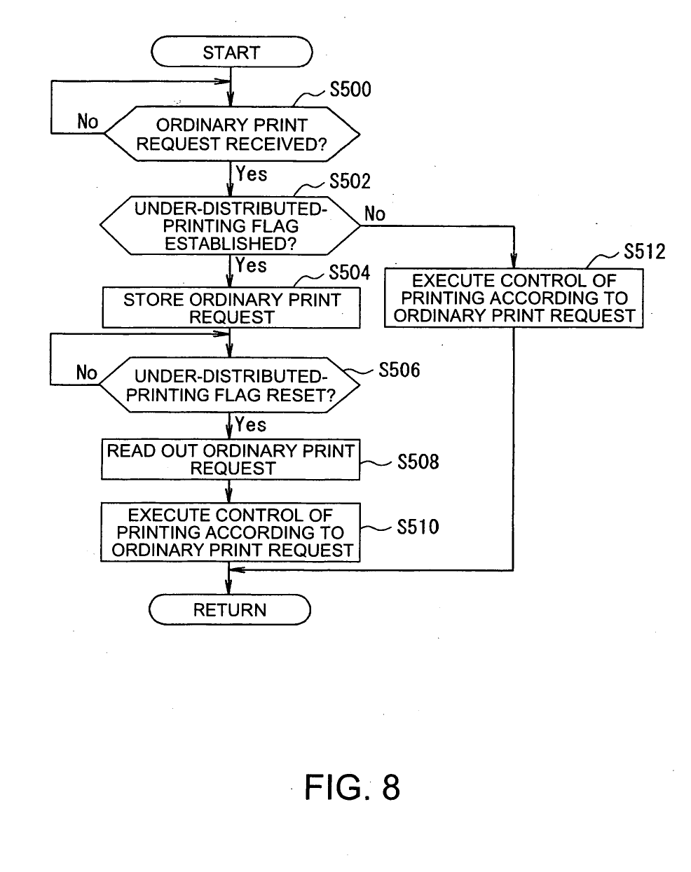

Referring to FIG. 8, explanation is now made regarding the ordinary-print request process.

FIG. 8 is a flowchart showing an ordinary-print request process.

The ordinary-print request process is a process to be realized as a part of the ordinary-print request receiving section 34 and print control section 38. When it is executed in the CPU 70, the process first moves to step S500 as shown in FIG. 8.

At step S00, it is determined whether or not an ordinary print request is received. When it is determined that an ordinary print request is received (Yes), the process moves to step S502. When it is determined not to be so (No), the process waits at step S500 until an ordinary print request is received.

At step S502, it is determined whether or not an under-distributed-printing flag is established. When it is determined that an under-distributed-printing flag is established (Yes), the process moves to step S504 where the received ordinary print request is stored in the storage device 82. The process then moves to step S506.

At step S506, it is determined whether or not the under-distributed-printing flag is reset. When it is determined that the under-distributed-printing flag is reset (Yes), the process moves to step S508 where the ordinary print request is read out of the storage device 82. The process then moves to step S510 where print data is read out of the read-out ordinary print request. Depending upon the extracted print data, the printing mechanism 84 is controlled to carry out a printing. The process in series is then terminated for return to the former process.

Meanwhile, when the under-distributed-printing flag is determined to be not reset at step S506 (No), the process waits at step S506 until the under-distributed-printing flag goes into a reset mode.

Meanwhile, when the under-distributed-printing flag is determined not to be established at step S502 (No), the process moves to step S512 where print data is extracted out of the received ordinary print request. Depending upon the extracted print data, the printing mechanism 84 is controlled to carry out a printing. The process in series is then terminated for return to the former process.

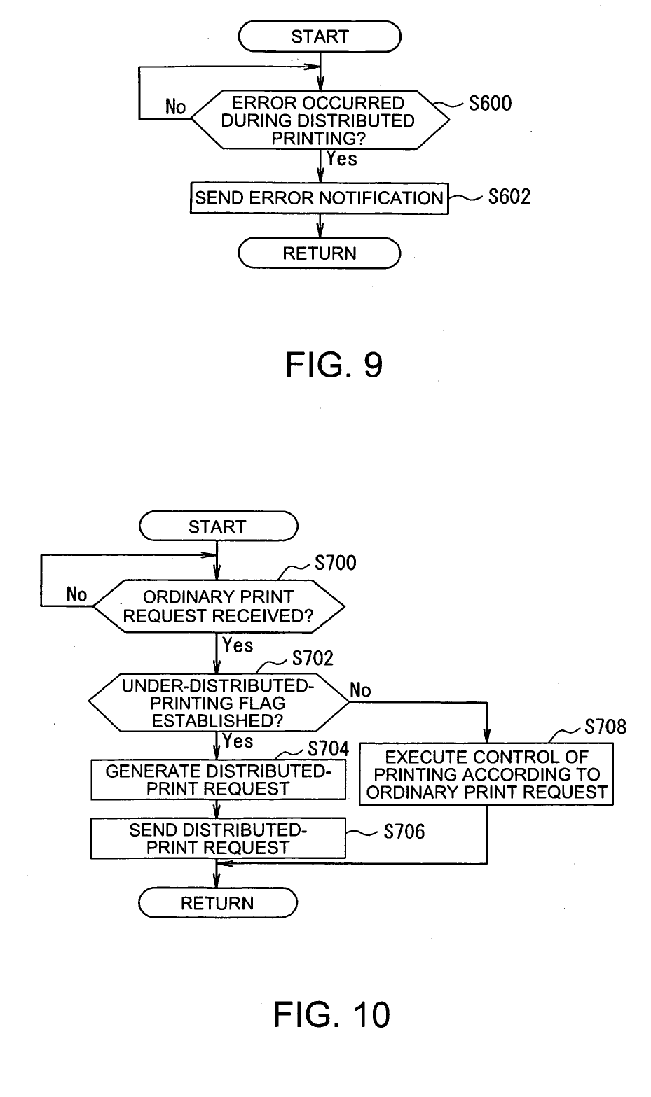

Referring to FIG. 9, explanation is now made regarding an error notification process.

FIG. 9 is a flowchart showing an error notification process.

When the error notification process is executed in the CPU 70, the process first moves to step S600, as shown in FIG. 9.

At step S600, it is determined whether or not there is an error occurrence during the distributed printing. When it is determined that an error occurred during the distributed-printing (Yes), the process moves to step S602 where an error notification is sent to the distributed-printing control server 200. The process in series is then terminated for return to the former process.

Meanwhile, when it is determined at step S600 that no errors occurred during the distributed printing (No), the process waits at step S600 until an error occurs in the distributed printing.

Explanation is now made regarding the operation of the present embodiment.

When making a distributed-printing of document data by utilization of a plurality of network printers 300, the user at the host terminal 100 is required to provide document data as a subject of printing to the distributed-printing application 10 and give an instruction by means of the distributed-printing application 10.

At the host terminal 100, when there is an instruction for printing from the user, the distributed-print request generating section 12 prompts the user to select the subjects-of-distributed-printing out of the plurality of network printers 300. Here, the user selects a subject-of-printing printer 300. When the subject-of-printing printer 300 is selected, the distributed-print request generating section 12 generates print data depending upon document data provided, thus generating a distributed-print request containing printer identification information for identifying the selected subject-of-printing printers 300 and generated print data. The generated distributed-print request is sent by the distributed-print request transmitting section 14 to the distributed-printing control server 200.

At the distributed-printing control server 200, when the distributed-print request is received, the process moves through S102 wherein printer identification information is extracted out of the received distributed-print request, to read a network address corresponding to the extracted printer identification information out of the printer information register table. Depending upon the read-out network address, a distributed-print start notification is sent to the subject-of-distributed-printing printer 300.

At the network printer 300, when the distributed-print start notification is received, it is determined whether or not the network printer 300 concerned is allowed for printing, depending upon the status information in the storage device 82. When it is determined that the printer is allowed for printing as a result thereof, a distributed-print start answer is sent to the distributed-printing control server 200 through step S204. Also, the under-distributed-printing flag is established through step S206, thus providing a non-printing status.

At the distributed-printing control server 200, when the distributed-print start answer is received, the process moves through steps S106-S110 wherein status information is acquired from the subject-of-distributed-printing printer 300 the distributed-print start answer has been made. The acquired status information is stored in the storage device 62 and registered as a subject-of-distributed-printing printer 300 allowed for printing. After lapse of a predetermined time from sending the distributed-print start notification, the received distributed-print request is divided through steps S114 and S116 depending upon the status information in the storage device 62, to generate distributed-unit-print requests for the respective subject-of- distributed-printing printers 300. The generated distributed-unit-print requests are sent to the respective subject-of-distributed-printing printers 300 depending upon the read-out network addresses.

At the network printer 300, when the distributed-unit-print request is received, the process moves through step S402 wherein print data is extracted out of the received distributed-unit-print request. Depending upon the extracted print data, the printing mechanism 84 is placed under control. As a result, the printing mechanism 84 makes a printing based on the distributed-print request. When the printing by the printing mechanism 84 is completed, a distributed-unit-print end notification is sent to the distributed-printing control server 200 through step S406.

At the distributed-printing control server 200, when the distributed-unit-print end notification is received, the process moves through step S122 wherein a distributed-print end notification is sent to the subject-of-distributed-printing printer 300 the distributed-unit-print end notification has been made, depending upon the read-out network address.

At the network printer 300, when the distributed-print end notification is received, the under-distributed-printing flag is reset and non-printing status is cancelled through step S210.

Meanwhile, at the network printer 300, when the ordinary print request is received in a non-printing status, the received ordinary print request is stored in the storage device 82 through step S504 because of the established under-distributed-printing flag. When the non-printing status is cancelled, the ordinary print request is read out of the storage device 82 through steps S508, S510. Print data is extracted from the read-out print request, and the printing mechanism 84 is placed under control depending upon the extracted print data. As a result, printing based upon the ordinary print request is performed by the printing mechanism 84.

Meanwhile, at the network printer 300, when an ordinary print request is received in a non-printing-cancelled status, the process moves through step S512 wherein print data is extracted from the received ordinary print request, to place the printing mechanism 84 under control depending upon the extracted print data. As a result, printing based upon the ordinary print request is performed by the printing mechanism 84.

Meanwhile, at the network printer 300, when an error of paper jamming or so occurs during distributed printing, an error notification is sent to the distributed-printing control server 200 through step S602.

At the distributed-printing control server 200, when the error notification is received, the process moves through steps S126, S128 wherein the subject-of-distributed-printing printer 300 the error notification has been made shares the unprocessed portion of printing to the remaining subject-of-distributed-printing printers 300. Accordingly, distributed-unit-print requests are generated for the respective ones of remaining subject-of-distributed-printing printers 300, and the generated distributed-unit-print requests are sent respectively to the subject-of-distributed-printing printers 300. Due to this, distributed-unit-print requests are additionally sent. Meanwhile, printing is cancelled as to the subject-of-distributed-printing printer 300 the error notification has been done.

At the network printer 300, when the additional distributed-unit-print request is received, the process moves through step S402 wherein print data is extracted from the received distributed-unit-print request, and the printing mechanism 84 is placed under control depending upon the extracted print data. As a result, additional printing based on the distributed-print request is performed by the print mechanism 84.

In this manner, in the present embodiment, the distributed-printing control server 200, when receiving a distributed-print request from the host terminal 100, sends a distributed-print start notification to the subject-of-distributed-printing printer 300 prior to a start of distributed printing, and generates a distributed-unit-print request according to the received distributed-print request. The generated distributed-unit-print request is sent to the subject-of-distributed-printing printer 300. After completing the distributed-printing, a distributed-print end notification is sent to the subject-of-distributed-printing printer 300. The network printer 300, when received a distributed-unit-print request or an ordinary print request, takes control of printing depending upon the received distributed-unit-print request or an ordinary print request. Meanwhile, as for the ordinary print request received in the time between a reception of distributed-print start notification and a reception of distributed-print end notification, printing is not made based on the ordinary print request.

Due to this, even in case an ordinary print request is sent to the network printer 300 under distributed-printing, printing based on the print request is not done. Accordingly, this can reduce the possibility of concurrently outputting the printing matter based on a distributed-print request and the printing matter based on an ordinary print request, as compared to conventional methods.

Furthermore, in the present embodiment, the network printer 300, when receiving an ordinary print request after receiving a distributed-print start notification, reserves the received ordinary print request in the storage device 82. Upon receiving a distributed-print end notification, print control is performed in accordance with the ordinary print request reserved in the storage device 82.

This allows the network printer 300 to accept an ordinary print request even when it is under distributed printing.

In the first embodiment, the host terminal 100 corresponds to the print-requesting terminal in form 2 or 26, the distributed-print request generating section 12 and distributed-print request transmitting section 14 correspond to distributed-print request transmitting section in form 2, and the distributed-printing control server 200 corresponds to the distributed-printing control terminal in form 2, 14, 19, 24 or 26. Meanwhile, the distributed-print request receiving section 18 and step S100 correspond to the distributed-print request receiving section in form 2 or 14, step S100 corresponds to the distributed-print request receiving step in form 19, 24 or 26, and the distributed-unit-print request generating section 20 and distributed-unit-print request transmitting section 24 and steps S114, 116 correspond to the distributed-unit-print request transmitting section in form 1, 2 or 14.

Meanwhile, in the first embodiment, steps 114, S116 correspond to the distributed-unit-print request transmitting step in form 19, 24 to 26, and the network printer occupying section 22 and steps S102, S122 correspond to the network printer occupying section in form 1, 2 or 14. Meanwhile, steps S102, S122 correspond to the network printer occupying step in form 19, 24 to 26, the print-request register DB 38 and storage device 82 correspond to the print request storing section in form 3, 7, 11, 16, 21 or 27, the distributed-unit-print request receiving section 32, ordinary print request receiving section 34 and steps S400, S500 correspond to the print request receiving section in form 1 to 3, 6, 7, 10 or 11.

Meanwhile, in the first embodiment, steps S400, S500 correspond to the print request reception in form 15, 16, 20, 21, 25 to 27, the print control section 38 and step S402, S502-S512 correspond to the print control section in form 1 to 3, 6, 7, 10 or 11. Meanwhile, steps S402, S502-S512 correspond to the print control in form 15, 16, 20, 21, 25 to 27.

Referring to the drawings, explanation is now made regarding a second embodiment of the invention. FIG. 10 is a figure showing a second embodiment of a distributed-printing control system, network printer, printer, distributed-printing control terminal, distributed-printing control program and storage medium, and distributed-printing control method according to the invention.

The present embodiment is the application of the distributed-printing control system, network printer, printer, distributed-printing control terminal, distributed-printing control program and storage medium, and distributed-printing control method of the invention, to the case that distributed printing is carried out with a plurality of network printers 300 under control of a distributed-printing control server 200 according to a distributed-print request from a host terminal 100. This is different from the first embodiment in that the ordinary print request received in a non-printing status is transferred as a distributed-print request to the distributed-printing control server 200. Incidentally, explanation is made below only on the different points from the first embodiment. The duplications with the first embodiments are attached with the same references, to omit explanations.

The CPU 70 is to execute an ordinary-print request process shown in a flowchart of FIG. 10, in place of the ordinary-print request process shown in the flowchart of FIG. 8.

FIG. 10 is a flowchart showing an ordinary-print request process.

When the ordinary-print request process is executed in the CPU 70, the process moves to step S700 as shown in FIG. 10.

At step S700, it is determined whether or not an ordinary print request is received. When it is determined that an ordinary print request is received (Yes), the process moves to step S702. When it is determined not to be so. (No), the process waits at step S700 until an ordinary print request is received.

At step S702, it is determined whether or not an under-distributed-printing flag is established. When it is determined that the under-distributed-printing flag is established (Yes), the process moves to step S704 where print data is extracted from the received ordinary print request, to generate a distributed-print request containing printer identification information and extracted print data. The process moves to step S706 where the generated distributed-print request is sent to the distributed-printing control server 200. The process in series is terminated for return to the former process.

Meanwhile, when it is determined at step S702 that the under-distributed-printing flag is not established (No), the process moves to step S708 where print data is extracted from the received ordinary print request. Depending upon the extracted print data, the printing mechanism 84 is placed under control thus carrying out a printing. The process in series is terminated for return to the former process.

The operation of the present embodiment is now explained.

At the network printer 300, when an ordinary print request is received in the non-printing status, because there is an established under-distributed-printing flag, the process passes steps S704, S706, wherein print data is extracted from the received ordinary print request, to generate a distributed-print request containing the printer identification information and extracted print data. The generated distributed-print request is sent to the distributed-printing control server 200.

At the distributed-printing control server 200, when the distributed-print request is received, the process moves through step S102 wherein printer identification information is extracted from the received distributed-print request. A network address corresponding to the extracted printer identification information is read out of the printer information register table. Depending upon the read-out network address, a distributed-print start notification is sent to the subject-of-distributed-printing printer 300.

At the network printer 300, when a distributed-print start notification is received, it is determined whether or not the network printer 300 concerned is allowed for printing depending upon the status information in the storage device 82. As a result, when it is determined that the printer is allowed for printing, a distributed-print start answer is sent to the distributed-printing control server 200 through step S204. Meanwhile, the under-distributed-printing flag is established into a non-printing status through step S206.

At the distributed-printing control server 200, when the distributed-print start answer is received, the process moves through steps S106-S110 wherein status information is acquired from the subject-of-distributed-printing printer 300 the distributed-print start answer was made. The acquired status information is stored in the storage device 62 and registered as a subject-of-distributed-printing printer 300 allowed for printing. Then, upon lapse of a predetermined time from transmitting the distributed-print start notification, the process moves through steps S114, S116. Depending upon the status information in the storage device 62, the received distributed-print request is divided to generate distributed-unit-print requests for the respective subject-of-distributed-printing printers 300. Depending upon the read-out network address, the generated distributed-unit-print requests are sent to the respective subject-of-distributed-printing printers 300.

At the network printer 300, when the distributed-unit print request is received, the process moves through step S402 wherein print data is extracted from the received distributed-unit print request. Thus, the printing mechanism 84 is placed under control depending upon the extracted print data. After completing the printing by the printing mechanism 84, a distributed-unit-print end notification is sent to the distributed-printing control server 200 through step S406.

At the distributed-printing control server 200, when the distributed-unit-print end notification is received, the process moves through step S122 wherein the distributed-unit-print end notification is sent to the subject-of-distributed-printing printer 300 distributed-unit-print end notification is made, depending upon the read-out network address.

At the network printer 300, when the distributed-unit-print end notification is received, the under-distributed-printing flag is reset, thereby canceling the non-printing status through step S210.

In this manner, in the present embodiment, the network printer 300, when receiving an ordinary print request in a time from receiving a distributed-print start notification to receiving a distributed-print end notification, is to send the received ordinary print request as a distributed-print request to the distributed-printing control server 200.

This allows the network printer 300 to accept an ordinary print request even when it is under distributed printing. Meanwhile, because the ordinary print request is to be processed as a distributed-print request, it is possible to efficiently implement a printing based on an ordinary print request.

In the second embodiment, the host terminal 100 corresponds to the print-requesting terminal in form 2 or 26, the distributed-print request generating section 12 and distributed-print request transmitting section 14 corresponds to distributed-print request transmitting section in form 2, and the distributed-printing control server 200 corresponds to the distributed-printing control terminal in form 2, 4, 8, 12, 14, 17, 19, 22, 24, 26 or 28. Meanwhile, the distributed-print request receiving section 18 and step S100 corresponds to the distributed-print request receiving section in form 2 or 14, step S100 corresponds to the distributed-print request reception in form 19, 24 or 26, and the distributed-unit-print request generating section 20 and distributed-unit-print request transmitting section 24 and steps S114, 116 correspond to the distributed-unit-print request transmitting section in form 1, 2 or 14.

Meanwhile, in the second embodiment, steps S114, S116 corresponds to the distributed-unit-print request transmission in form 19, 24 or 26, and the network printer occupying section 22 and steps S102, S122 correspond to the network printer occupying section in form 1, 2 or 14. Meanwhile, steps S102, S122 corresponds to the network printer occupation in form 19 or 24 to 26, the distributed-unit-print request receiving section 32, ordinary unit-print request receiving section 34 and steps S400, S700 correspond to the print-request receiving section in form 1, 2, 4, 6, 8, 10 or 12.

Meanwhile, in the second embodiment, steps S400, S700 correspond to the print request reception in form 15, 17, 20, 22, 25, 26 or 28, steps S402, S702-S708 correspond to the print control section in form 1, 2, 4, 6, 8, 10 or 12 or the print control in form 15, 17, 20, 22, 25, 26 or 28.

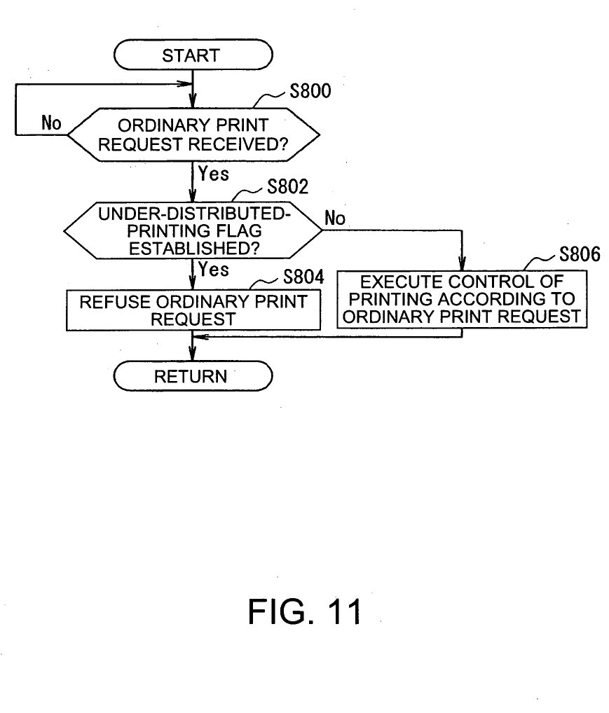

Referring to the drawings, explanation is now made regarding a third embodiment of the invention. FIG. 11 is a figure showing a third embodiment of a distributed-printing control system, network printer, printer, distributed-printing control terminal, distributed-printing control program and storage medium, and distributed-printing control method according to the invention.

The present embodiment is the application of the distributed-printing control system, network printer, printer, distributed-printing control terminal, distributed-printing control program and storage medium, and distributed-printing control method of the invention to the case that distributed-printing is implemented by means of a plurality of network printers 300 under control of a distributed-printing control server 200 according to a distributed-print request from a host terminal 100. This is different from the first embodiment in that refused is the ordinary print request received in the non-printing status. Incidentally, explanation is made below only on the different points from the first embodiment. The duplications with the first embodiments are attached with the same references, to omit explanations.

The CPU 70 is to execute an ordinary-print request process shown in a flowchart of FIG. 11, in place of the ordinary-print request process shown in the flowchart of FIG. 8.

FIG. 11 is a flowchart showing an ordinary-print request process.

When the ordinary-print request process is executed in the CPU 70, the process moves to step S800 as shown in FIG. 11.

At step S800, it is determined whether or not an ordinary print request is received. When it is determined an ordinary print request is received (Yes), the process moves to step S802. When it is determined not to be so (No), the process waits at step S800 until an ordinary print request is received.

At step S802, it is determined whether or not the under-distributed-printing flag is established. When it is determined that the under-distributed-printing flag is established (Yes), the process moves to step S804 where refusal is made by discarding the received ordinary print request. The process in series is terminated for return to the former process.

Meanwhile, when it is determined at step S802 that the under-distributed-printing flag is not established (No), the process moves to step S806 where print data is extracted from the received ordinary print request. Depending upon the extracted print data, the printing mechanism 84 is placed under control thus effecting a printing. The process in series is terminated for return to the former process.

The operation of the present embodiment is now explained.

At the network printer 300, when an ordinary print request is received in the non-printing status, the under-distributed-printing flag is being established and hence the process moves through step S804 wherein the received ordinary print request is discarded and thereby refused. Thereupon, the transmission source of the ordinary print request is notified of the refusal.

In this manner, in this embodiment, the network printer 300, when receiving an ordinary print request in the time of between receiving a distributed-print start notification and receiving a distributed-print end notification, refused is the received ordinary print request.

This prohibits the network printer 300 under distributed-print from accepting an ordinary print request, and hence can reduce the possibility of effecting the distributed-printing now under processing.

In the third embodiment, the host terminal 100 corresponds to the print-requesting terminal in form 2 or 26, the distributed-print request generating section 12 and distributed-print request transmitting section 14 correspond to the distributed-print request transmitting section in form 2, and the distributed-printing control server 200 corresponds to the distributed-printing control terminal in form 2, 14, 19, 24 or 26. Meanwhile, the distributed-print request receiving section 18 and step S100 correspond to the distributed-print request receiving section in form 2 or 14, step S100 corresponds to the distributed-print request reception in form 19, 24 or 26, and the distributed-unit-print request generating section 20 and distributed-unit-print request transmitting section 24 and steps S114, 116 correspond to the distributed-unit-print request transmitting section in form 1, 2 or 14.

Meanwhile, in the third embodiment, steps S114, S116 corresponds to the distributed-unit-print request transmission in form 19, 24 or 26, and the network printer occupying section 22 and steps S102, S122 correspond to the network printer occupying section in form 1, 2 or 14. Meanwhile, steps S102, S122 correspond to the network printer occupation in form 19 or 24 to 26, and the distributed-unit-print request receiving section 32, ordinary unit-print request receiving section 34 and steps S400, S800 correspond to the print-request receiving section in form 1, 2, 6 or 10.

Meanwhile, in the third embodiment, steps S400, S800 correspond to the print request reception in form 15, 20, 25 or 26, steps S402, S802-S806 correspond to the print control section in form 1, 2, 5, 6, 9, 10 or 13 or to the print control in form 15, 18, 20, 23, 25, 26 or 29.

Incidentally, although the first to third embodiments configured the distributed-printing control server 200 to additionally send a distributed-unit-print request when it receives an error notification, this is not limitative. Namely, a configuration can be made to additionally send a distributed-unit-print request in order to efficiently perform a distributed-printing now under processing when receiving a new-participation representing that a new network printer 300 participated the network 199, an inoperative notification representing that the subject-of-distributed-printing printer 300 became inoperative or other status notification representative of another status.

Meanwhile, although the second embodiment configured the network printer 300 to transfer the received ordinary print request as a distributed-print request to the distributed-print control server 200, this is not limitative. Alternatively, the ordinary print request received in a non-printing status can be transferred as it is to another network printer 300.

Meanwhile, although the first to third embodiments configured the network printer 300 to reserve, transfer and refuse the ordinary print request received in the non-printing status, this is not limitative. Alternatively, those are to be configured to selectively reserve, transfer and refuse it. Specifically, the following two configurations can be proposed.

In a first configuration, the network printer 300 is previously set in any of reserve mode, transfer mode and refusal mode so that the ordinary print request received in the non-printing status can be processed in the mode established.

In a second configuration, the distributed-printing control server 200 is to transfer to the network printer 300 a distributed-unit-print request containing any designation of reserve mode, transfer mode and refusal mode so that the network printer 300 can process a received ordinary print request received in the non-printing status, in the designation mode contained in the received distributed-unit-print request. In this case, designation mode may be changed for each of network printers 300 or of distributed-print requests.

Meanwhile, although the first to third embodiments configured the network printer 300 to establish an under-distributed-printing flag when received a distributed-print start notification, this is not limitative. Alternatively, a configuration may be such that the distributed-printing control server 200 does not send a distributed-print start notification while the network printer 300 when receiving a distributed-unit-print request establishes an under-distributed-printing flag.

Meanwhile, although the first to third embodiments configured the network printer 300 to reset the under-distributed-printing flag when it received a distributed-print end notification, this is not limitative. Alternatively, a configuration may be such that the distributed-printing control server 200 does not send a distributed-print end notification while the network printer 300, when it is determined to be a completion of printing based on the distributed-unit-print request, the under-distributed-printing flag is reset.

Meanwhile, although the first to third embodiments were configured by providing the distributed-printing control server 200, this is not limitative. Alternatively, a configuration can be without providing the distributed-printing control server 200. In such a case, the status-information acquiring section 16, distributed-print request receiving section 18, distributed-unit-print request generating section 20, network printer occupying section 22 and distributed-unit-print request transmitting section 24 may all be provided within the host terminal 100 or within the network printer 300. Otherwise, a part of them may be provided within the host terminal 100 while the remainder is within the network printer 300. Where provided in a part or all of those within the host terminal 100, the distributed-print request transmitting section 14 and the distributed-print request receiving section 18 are unnecessary.

Meanwhile, although the first to third embodiments provided the status-information register DB 26 and print-request register DB 28 as an external device of the network printer 300, this is not limitative. Alternatively, a configuration may be such that the status-information register DB 26 or the print-request register DB 28 is provided in a desired terminal on the network 199 so that the network printer 300 can make use of DBs 26, 28 of those terminals.

Meanwhile, although the first to third embodiments configured the distributed-print request by containing therein printer identification information and print data, this is not limitative. Alternatively, it can be configured containing an identifier of a network printer 300 to serve as a subject of distributed printing, and additional information about the necessity/non-necessity of a distributed-printing result notification and distributed-printing policy (speed and quality). Alternatively, the distributed-print request can comprise the printer identification information. In this case, the network printer 300 to serve as a subject of distributed-printing previously holds print data. The distributed-printing control server 200 is to send a distributed-unit-print request containing an identifier of print data to each network printers 300 while the network printer 300 searches for print data on the basis of the identifier contained in the distributed-unit-print request and effects a printing depending upon print data searched. Furthermore, in case the subject-of-distributed-printing printer 300 uses a network printer 300 previously set in the distributed-printing control server 200 or a network printer 300 which the distributed-printing control server 200 searched continuously or at a time point of receiving a print request, the distributed-print request can be made by only print data without including printer identification information.

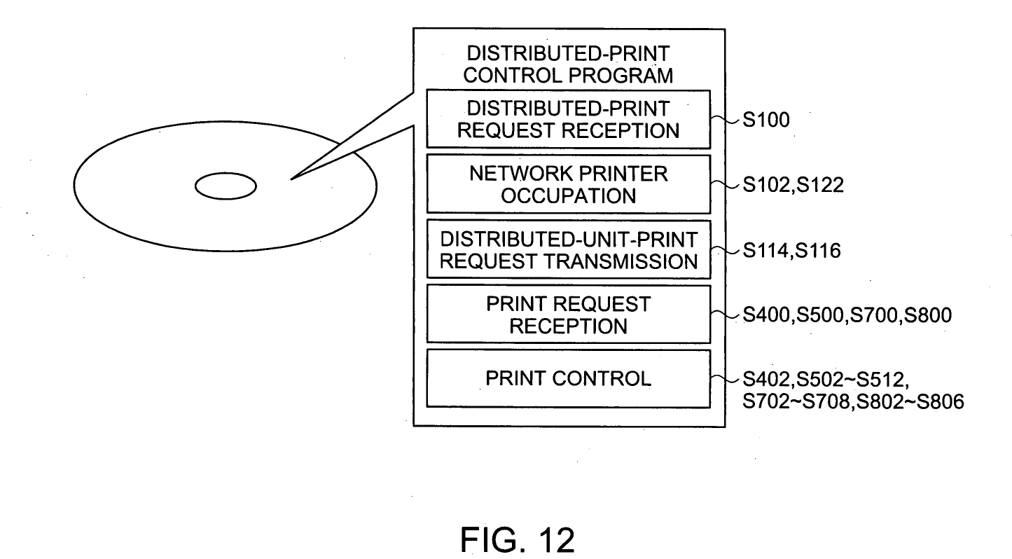

Meanwhile, although the first to third embodiment were explained on the case of executing the control program previously stored in the ROM 52, 72 when executing the process shown in the flowchart of FIG. 3, 5 to 11, this is not limitative. Alternatively, the program may be executed from a storage medium storing the program showing the procedure onto the RAM 54, 74, as shown in FIG. 12.

FIG. 12 is a figure showing a storage medium and its data structure.

Here, the storage medium refers to a semiconductor storage medium such as a RAM or a ROM, a magnetic storing schemed storage medium such as an FD or HD, an optical reading type of storage medium such as a CD, a CDV, an LD or a DVD, or a magnetic storing schemed/optical reading schemed storage medium such as an MO, including any storage medium provided it is a storage medium readable by a computer regardless of whether the reading method is electronic, magnetic or optical.

Meanwhile, the first to third embodiments were applications of the distributed-printing control system, network printer, printer, distributed-printing control terminal, distributed-printing control program and storage medium, and distributed-printing control method of the invention to a case that distributed-printing is implemented with a plurality of network printers 300 under control of a distributed-printing control server 200 according to a distributed-print request from a host terminal 100. However, application is possible to other cases within a scope not departing from the gist of the invention without limitation to the above.

1. A distributed-printing control system communicably connected with a plurality of network printers and for effecting control of distributed printing, the system comprising:
a network printer occupying section that occupies, during distributed printing, the network printer to serve as a subject of distributed-printing among the plurality of network printers; and
a distributed-unit-print request transmitting section that transmits a distributed-unit-print request for a printing handled by one network printer out of a distributed printing, to the subject-of-distributed-printing printer depending upon a distributed-print request for distributed printing;
the network printer including a print request receiving section for receiving the distributed-unit-print request or another print request, and a print control section for effecting control of printing depending upon a distributed-unit-print request or the other print request received at the print request receiving section;
the network printer occupying section selectively sending a distributed-print start notification representative of a start of distributed printing to the subject-of-distributed-printing printer before a start of distributed printing, and a distributed-print end notification representative of an end of distributed printing to the subject-of-distributed-printing printer after an end of distributed printing;
the print control section selectively preventing a printing as to the other print request received at the print request receiving section in a time from a reception of the distributed-print start notification to a reception of the distributed-print end notification.

2. A distributed-printing control system communicably connected with a print-requesting terminal for placing a request for printing, a plurality of network printers and a distributed-printing control terminal for control of the network printers, and for effecting control of distributed printing,
the print-requesting terminal having a distributed-print request transmitting section that sends a distributed-print request for distributed printing to the distributed-printing control terminal;
the distributed-printing control terminal having a distributed-print request receiving section that receives the distributed-print request, a network printer occupying section that occupies the network printer to serve as a subject of distributed printing among the plurality of network printers, and a distributed-unit-print request transmitting section that sends a distributed unit-print request for a printing handled by one network printer out of a distributed printing, to the subject-of-distributed-printing printer depending upon a distributed-print request received at the distributed-print request receiving section;
the network printer having a print request receiving section that receives the distributed-unit-print request or other print request, and a print control section that effects control of printing depending upon the distributed-unit-print request or other print request received at the print request receiving section;
the network printer occupying section selectively sending a distributed-print start notification representative of a start of distributed printing to the subject-of-distributed-printing printer before a start of distributed printing, and a distributed-print end notification representative of an end of distributed printing to the subject-of-distributed-printing printer after an end of distributed printing;
the print control section selectively preventing a printing as to the other print request received at the print request receiving section in a time from a reception of the distributed-print start notification to a reception of the distributed-print end notification.

3. The distributed-printing control system according to claim 2, wherein the network printer has a print request storing section that stores the other print request, the print control section reserving the received other print request in the print request storing section when receiving the other print request at the print request receiving section after receiving the distributed print start notification, and effecting control of printing depending upon the other print request reserved in the print request storing section when receiving the distributed print end notification.

4. The distributed-printing control system according to claim 2, wherein the print control section selectively sending the received other print request as the distributed print request to the distributed printing control terminal when receiving the other print request at the print request receiving section in a time from a reception of the distributed print start notification to a reception of the distributed print end notification.

5. The distributed-printing control system according to claim 2, wherein the print control section refuses the other print request in a time from a reception of the distributed print start notification to a reception of the distributed print end notification.

6. A network printer for effecting control of printing depending upon a distributed-unit-print request for a printing handled by one network printer out of a distributed printing, the printer comprising:
a print request receiving section that receives the distributed-unit-print request or other print request; and
a print control section that effects control of printing depending upon a distributed-unit-print request received at the print request receiving section or another print request;
the print control section selectively preventing a printing as to the other print request received at the print request receiving section in a time from a reception of a distributed print start notification representative of a start of distributed printing to a reception of a distributed print end notification representative of an end of distributed printing.

7. The network printer according to claim 6, including a print request storing section that stores the other print request, the print control section reserving a received other print request in the print request storing section when receiving the other print request at the print request receiving section after receiving the distributed print start notification and, effecting control of printing depending upon the other print request reserved in the print request storing section when receiving the distributed print end notification.

8. The network printer according to claim 6, wherein the network printer is communicably connected with a distributed-printing control terminal for effecting control of the network printers depending upon a distributed print request for distributed printing, the print control section selectively sending a received other print request as the distributed print request to the distributed printing control terminal when receiving the other print request at the print request receiving section in a time from a reception of the distributed print start notification to a reception of the distributed print end notification.

9. The network printer according to claim 6, wherein the print control section refuses the other print request in a time from a reception of the distributed print start notification to a reception of the distributed print end notification.

10. A printer for effecting control of printing depending upon a distributed-unit-print request for a printing handled by one network printer out of a distributed printing, the printer comprising:
a print request receiving section that receives the distributed-unit-print request or other print request; and
a print control section that takes control of printing depending upon a distributed-unit-print request received at the print request receiving section or another print request;
the print control section selectively preventing a printing as to the other print request received at the print request receiving section in a time from a reception of a distributed print start notification representative of a start of distributed printing to a reception of a distributed print end notification representative of an end of distributed printing.

11. The printer according to claim 10, including a print request storing section that stores the other print request, the print control section reserving a received other print request in the print request storing section when receiving the other print request at the print request receiving section after receiving the distributed print start notification and effecting control of printing depending upon the other print request reserved in the print request storing section when receiving the distributed print end notification.

12. The printer according to claim 10, wherein the printer is communicably connected with a distributed-printing control terminal for effecting control of the network printers depending upon a distributed print request for distributed printing, the print control section selectively sending a received other print request as the distributed print request to the distributed printing control terminal when receiving the other print request at the print request receiving section in a time from a reception of the distributed print start notification to a reception of the distributed print end notification.

13. The printer according to claim 10, wherein the print control section refuses the other print request in a time from a reception of the distributed print start notification to a reception of the distributed print end notification.

14. A distributed-printing control terminal communicably connected with a plurality of network printers and for effecting control of the network printers, the terminal comprising:
a distributed-print request receiving section that receives a distributed-print request for distributed printing;
a network printer occupying section that occupies the network printer to serve as a subject of distributed printing among the plurality of printers during distributed printing;
a distributed-unit-print request transmitting section that sends a distributed-unit-print request for a printing handled by one of the network printers out of a distributed printing depending upon a distributed print request received at the distributed-print request receiving section;
the network printer occupying section selectively sending a distributed-print start notification representative of a start of distributed printing to the subject-of-distributed-printing printer before a start of distributed printing, and a distributed-print end notification representative of an end of distributed printing to the subject-of-distributed-printing printer after an end of distributed-printing.

15. A distributed-printing control program to be executed by a computer operating as a network printer and for effecting control of printing depending upon a distributed-unit-print request for a printing handled by one network printer out of a distributed printing, the program including a program for the computer to execute a process comprising:
receiving the distributed-unit-print request or another print request; and
effecting control of printing depending upon the distributed-unit-print request or the other print request received at the print request receiving section;
the print control selectively preventing a printing as to another print request received in the print request reception in a time from a reception of a distributed print start notification representative of a start of distributed printing to a reception of a distributed print end notification representative of an end of distributed printing.

16. A distributed-printing control program to be executed by a computer operating as a distributed-printing control terminal communicably connected with a plurality of network printers and for effecting control of the network printer, the program including a program for the computer to execute a process comprising:
receiving a distributed-print request for distributed printing;
occupying the network printer to serve as a subject of distributed printing among the plurality of printers during distributed printing;
sending a distributed-unit-print request for a printing handled by one of the network printers out of a distributed printing depending upon a distributed print request received at the distributed-print request receiving section to the subject-of-distributed-printing printer;
the network printer occupation selectively sending a distributed-print start notification representative of a start of distributed printing to the subject-of-distributed-printing printer before a start of distributed printing, and a distributed-print end notification representative of an end of distributed printing to the subject-of-distributed-printing printer after an end of distributed-printing.

17. A computer-readable storage medium storing a distributed-printing control program to be executed by a computer operating as a network printer and for effecting control of printing depending upon a distributed-unit-print request for a printing handled by one network printer out of a distributed printing, the medium recording a program for the computer to execute a process comprising:
receiving the distributed-unit-print request or another print request; and
effecting control of printing depending upon a distributed-unit-print request or the other print request received at the print request receiving section;
the print control selectively preventing a printing as to another print request received in the print request receiving section in a time from a reception of a distributed print start notification representative of a start of distributed printing to a reception of a distributed print end notification representative of an end of distributed printing.

18. A computer-readable storage medium storing a distributed-printing control program to be executed by a computer operating as a distributed-printing control terminal communicably connected with a plurality of network printers and for effecting control of distributed printing, the medium recording a program for the computer to execute a process comprising:
receiving a distributed-print request for distributed printing;
occupying the network printer as a subject of distributed printing among the plurality of printers during distributed printing;
sending a distributed-unit-print request for a printing handled by one of the network printers out of a distributed printing depending upon a distributed print request received in the distributed-print request receiving section to the subject-of-distributed-printing printer;
the network printer occupation selectively sending a distributed-print start notification representative of a start of distributed printing to the subject-of-distributed-printing printer before a start of distributed printing, and a distributed-print end notification representative of an end of distributed printing to the subject-of-distributed-printing printer after an end of distributed-printing.

19. A distributed-printing control method that communicably connects with a plurality of network printers and for effecting control of distributed printing, the method comprising:
occupying the network printer to serve as a subject of distributed printing among the plurality of network printers, during distributed printing; and
sending a distributed-unit-print request for a printing handled by one of the network printers out of a distributed printing depending upon a distributed-print request for distributed printing, to the subject-of-distributed-printing printer;
wherein, included for the network printer are:
receiving the distributed-unit-print request or other print request, and effecting control of printing depending upon the distributed-unit-print request or other print request received in the print request reception;
the network printer occupation selectively sending a distributed-print start notification representative of a start of distributed printing to the subject-of-distributed-printing printer before a start of distributed printing, and a distributed-print end notification representative of an end of distributed printing to the subject-of-distributed-printing printer after an end of distributed printing;
the print control selectively preventing a printing as to the other print request received in the print request reception in a time from a reception of the distributed-print start notification to a reception of the distributed-print end notification.

20. A distributed-printing control method that communicably connects with a print-requesting terminal for requesting for printing, a plurality of network printers and a distributed-printing control terminal for control of the network printers, and for effecting control of distributed printing, the method comprising:
for the print-requesting terminal:
sending a distributed-print request for distributed printing to the distributed-printing control terminal;
for the distributed-printing control terminal:
receiving the distributed-print request;
occupying the network printer to serve as a subject of distributed-printing among the plurality of network printers; and
sending a distributed-unit-print request for a printing handled by one of the network printers out of a distributed printing depending upon the distributed-print request received in the distributed-print request reception, to the subject-of-distributed-printing printer;
for the network printer:
receiving the distributed-unit-print request or other print request; and
effecting control of printing depending upon the distributed-unit-print request or other print request received in the print request reception;
the network printer occupation selectively sending a distributed-print start notification representative of a start of distributed printing to the subject-of-distributed-printing printer before a start of distributed printing, and a distributed-print end notification representative of an end of distributed printing to the subject-of-distributed-printing printer after an end of distributed printing;
the print control selectively preventing a printing as to the other print request received in the print request reception in a time from a reception of the distributed-print start notification to a reception of the distributed-print end notification.
